(19) United States
(12) Patent Application Publication
(10) Pub. No.: US 2012/0281970 A1
(43) Pub. Date: Nov. 8, 2012

(54) MEDICAL VIDEO PRODUCTION AND DISTRIBUTION SYSTEM

(76) Inventors: Jeffrey M. Garibaldi, St. Louis, MO (US); Claude Greer, St. Louis, MO (US); Walter M. Blume, St. Louis, MO (US)

(21) Appl. No.: 13/463,058

(22) Filed: May 3, 2012

Related U.S. Application Data
(60) Provisional application No. 61/482,201, filed on May 3, 2011.

(51) Int. Cl. H04N 5/93; G06K 9/18; H04N 7/15

(52) U.S. Cl. 386/278; 348/14.08; 382/182; 386/E05.003; 348/E07.083

(57) ABSTRACT

A consolidated system for performing, recording, and distributing the performance and/or recordation of medical procedures, including a plurality of computer-controlled medical systems each having one or more input devices; and an aggregation system for aggregating information pertaining to a medical procedure and/or pertaining to the use of one or more of the medical systems to perform a medical procedure, the information having a plurality of sources, forms, and formats. The aggregation system is configured to provide a preview of the information to allow a user to combine and/or edit the information and provide transmission of the combined and/or edited information to one or more recipients via a network.

### CROSS-REFERENCE TO RELATED APPLICATIONS

This application claims the benefit of U.S. Provisional Application No. 61/482, 201, filed on May 3, 2011. The entire disclosure of the above application is incorporated herein by reference.

### BACKGROUND

This disclosure relates to a medical video production and distribution system.

Many modern medical procedures involve the use of multiple separate computer-controlled medical systems. These systems have input devices (typically a keyboard and a mouse) and generate a display for the user. While it can be challenging for a physician or other healthcare professional to simultaneously operate these separate programs, at least one system is available that consolidates the displays from each of a plurality of separate computer-controlled medical systems onto a composite display, and provides a single set of control devices, for example, a keyboard, mouse, and/or other controller that will control the separate computer-controlled medical system whose corresponding display on the composite display includes the system cursor. The user can manipulate the cursor to the particular display on the composite display corresponding to the system the user wants to operate, and once the cursor is there, use the set of control devices to operate that separate computer system. An example of such a system is the Odyssey System, available from Stereotaxis, Inc., St. Louis, Mo.

For a variety of reasons it may be desirable to document the medical procedure by recording the displays of each of the separate computer-controlled medical systems. Systems for capturing and distributing and/or recording the image from the composite screen have also been developed for this purpose. One such system for video storage and distribution is the Odyssey Cinema System, available from Stereotaxis, Inc., St. Louis, Mo.

### SUMMARY

Existing composite medical displays that simply aggregate the displays from a plurality of separate medical systems used in performing a medical procedure can provide a lot of useful information about the medical procedure. However, there are a number of shortcomings to simply distributing this composite display. First, in order to preserve useful image quality, it can be desirable to use a proprietary codec to compress the video signal before transmission and storage. However, the use of a proprietary codec normally interferes with the widespread distribution because the recipients usually need corresponding proprietary software or hardware. Second, in distributing the video signal outside of the originating institution, steps must be taken to protect the identity and personal healthcare information of the patient that is embedded within the individual displays comprising the composite display. Third, the raw video of the composite display, while full of information, is not particularly instructive to students and the inexperienced. It is desirable to integrate other relevant video and audio sources to embellish the event and add explanatory information, information from a telepresence system in the procedure room, and/or narration, in real-time.

### BRIEF DESCRIPTION OF THE DRAWINGS

FIG. 1 is a schematic diagram of an existing system for integrating the display and control of a multiple separate computer-controlled medical systems;

FIG. 2 is a schematic diagram of an embodiment of a medical video production and distribution system, in accordance with the principles of this disclosure;

FIG. 3 is a flow chart of the implementation of one embodiment of a medical video production and distribution system, in accordance with the principles of this disclosure; and

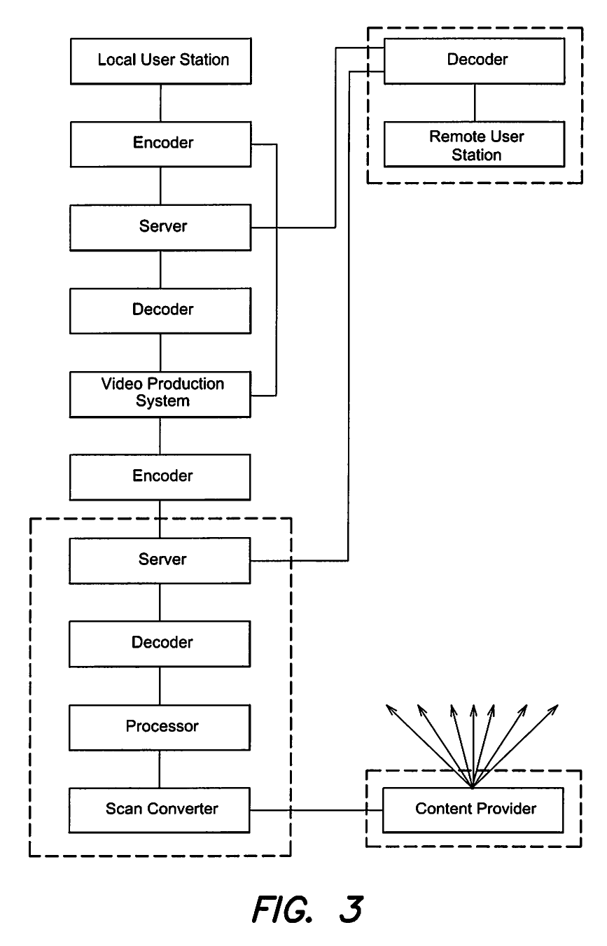

FIG. 4 is a schematic diagram of an embodiment of a remote computer for use by a remote participant of the medical video production and distribution.

### DETAILED DESCRIPTION

An increasingly important aspect of modern medical procedures is the remote sharing of these medical procedures. Remote sharing allows experienced physicians to share their experience over an unlimited geography, either directly controlling the medical procedure, or simply providing guidance and supervision. Remote share also allows medical students and less experienced physicians to watch medical procedures being conducted by experts, and learn how to perform the procedures themselves. In accordance with various implementations of the disclosure, the remote sharing of medical procedures can be provided with high definition video broadcast easily generated from a variety of sources of video and audio into a single consolidated transmission that can be accessed around the world. A system may be provided to aggregate the sources of information, including PowerPoint, video clips, moderator video, lab video, procedure consolidated view, among other sources along with the audio corresponding with each to form a comprehensive medical collaboration event or Internet broadcast. This can involve the use of a proprietary codec to maintain desired quality, high data transmission rates for high definition video, the editing of the content of a video stream that leaves an institution, an ability to provide commentary and instruction, and an ability to protect patient identity and confidentiality.

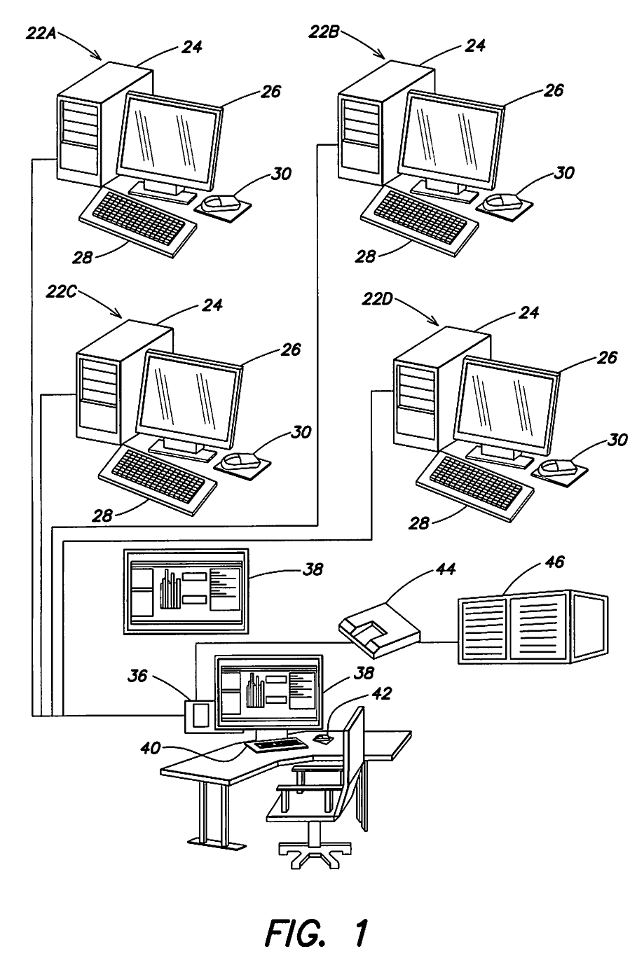

An existing system for the coordinated display and control of multiple separate computer-controlled medical systems is indicated generally as 20 in FIG. 1. This system comprises a plurality of separate computer-controlled medical systems 22A-D. Each of these separate computer-controlled medical systems 22A-D comprises a processor 24, a display 26, and one or more input devices, such as a keyboard 28 and a mouse 30. These separate computer systems can include, for example a remote navigation system for remotely controlling the position and orientation of the distal end of an elongate medical device in an operating region in a patient; a localization system for determining and displaying the location and/or orientation of the distal end of the medical device in the operating region in the patient; a medical imaging system for imaging the operating region in the patient; and a electrocardiographic system for monitoring electrical activity of the heart. These are just examples, and there could be fewer, additional, and/or different separate computer-controlled medical systems depending upon the nature of the procedure being conducted.

Each of these separate computer-controlled medical systems 22A-D is preferably connected to a consolidating and controlling computer system 34. This consolidating and controlling computer system 34 can comprise a processor 36, a display 38, and one or more input devices, such as a keyboard 40 and a mouse 42. The consolidating and controlling computer system 34 consolidates the individual displays from the separate computer-controlled medical systems 22A-D onto a composite display on display 38. The consolidating and controlling computer system 34 also allows control of each of the separate computer-controlled medical systems 22A-D with the keyboard 40 and mouse 42. The consolidating and controlling computer system 34 is preferably programmed, so that the keyboard 40 and mouse 42 automatically control the separate computer-controlled medical system 22 whose display on the composite display 38 displays a cursor. An example of such a system is disclosed in U.S. Pat. No. 7,567,233, Global Input Device For Multiple Computer-Controlled Medical Systems, the entire disclosure of which is incorporated herein by reference. Such a system can also be adapted for the simultaneous control of two or more computers. An example of such a system is disclosed in U.S. Pat. No. 7,747,960, entitled Control For, And Method Of, Operating At Least Two Medical Systems, the entire disclosure of which is incorporated herein by reference.

The video signal from the display 38 is transmitted to an encoder/decoder 44 that converts the video signal into an ip packet based video stream, preferably using a codec that emphasizes frame quality over frame rate, with low latency. The converted video signal can be transmitted over an existing local area network to a server 46, which can store the signals in their converted form and/or distribute the converted signal to the computers of others in real-time via the local area network or a virtual private network.

In accordance with a preferred embodiment of the systems and methods of this disclosure, the ip packet based video stream can be provided to a studio production console which facilitates collaboration, broadcasting, and presentation editing. The studio production console 50 comprises a processor 52, first and second displays 54 and 56, and input devices, such as keyboard 58 and mouse 60. In addition, the console could include additional or alternative input devices, such as a pen tablet which could be used with telestrator software during collaboration and broadcast events. The studio production console 50 may also integrate with the video and audio of a telepresence system and a conventional web camera 62 and a microphone 64, so that the user can add video and audio annotations to the video or audiovisual signal from the display 38 of the system 34 of the lab staff and moderator, respectively.

The studio production console 50 can access the consolidated procedure information in the form of an ip packet based video stream consisting of live or recorded images from the server 46, via an encoder/decoder 64 that decodes the ip packet based video stream into a displayable image on the studio production console.

The processor 52 can include video editing software, such as Cam Studio available at http://camstudio.org/, Camtasia Studio available from TechSmith Corporation, or Adobe Premier available from Adobe Systems Incorporated, or other custom developed presentation editing software which captures the displayable images, and allows the images to be combined with additional visual and audio images. In accordance with one aspect of this disclosure, the studio production console includes a plurality of displays (preferably two) which are set-up so that display 54 acts as a preview display and display 56 acts as a transmit display. The processor 52 is setup so that the user can size and position a plurality of different content sources on the preview display 54 during a collaboration and broadcast event which will not be seen by the remote audience. The user can move these sources across the desktop from the preview display to the transmit display 56 at any time during the collaboration and broadcast event sizing and positioning each source for the remote audience to see. The processor 52 is designed to send the contents of the transmit display to the remote audience. The audio of each of the corresponding sources is enabled and disabled by the studio production console, such that all enabled audio sources are combined and delivered synchronously with the video of the transmit display. In accordance with the principles of this disclosure, the user can select from and arrange at least one of (a) A procedure video or an audiovisual system signal representing a composite of the displays of a plurality of computer based medical systems used in conducting the procedure; (b) A procedure room video or audiovisual signal from a procedure room telepresence system; (c) A local video or audiovisual signal from a local telepresence system or a web camera and/or microphone.; (d) Various supplementary content, including web pages, PowerPoint slides, images, audio files, video files and images, among other relevant audio/video sources. The user can arrange this visual data on the transmit display and can select or combine the various audio sources for this collaboration or broadcast event, for example, selectively combining the procedure visual or audiovisual signal with the procedure room video or audiovisual signal and/or narration from the local video or audiovisual signal, to create a produced video or audiovisual signal.

Thus, the procedure video or audiovisual system signal can be easily transmitted with supplementary audio and/or video signals from the procedure room, from the operator of the production system or from other sources simply by positioning sources in the transmit display. The operator of the production system can edit the information being transmitted from the institution, and provide contextual and explanatory information.

The procedure video or audiovisual signal can be provided by using a proprietary codec to communicate the video or audiovisual signal via a network. This network is preferably a preexisting wireless or wired conventional network in the healthcare facility, but could be a special network established from this purpose. Similarly, the procedure room video or audiovisual signal can be provided by a propriety or conventional codec to communicate the video or audiovisual signal via a network.

The resulting produced video or audiovisual signal from the transmit display of the studio production console can be communicated by a conventional mean or preferably a proprietary codec via a virtual private network (vpn) to a central network gateway 70. While other means of communication could be used, this allows wide distribution of the produced video or audiovisual signal through a single vpn from each institution to the central network location, rather than requiring the establishment of multiple vpn's at each source institution, one with each recipient.

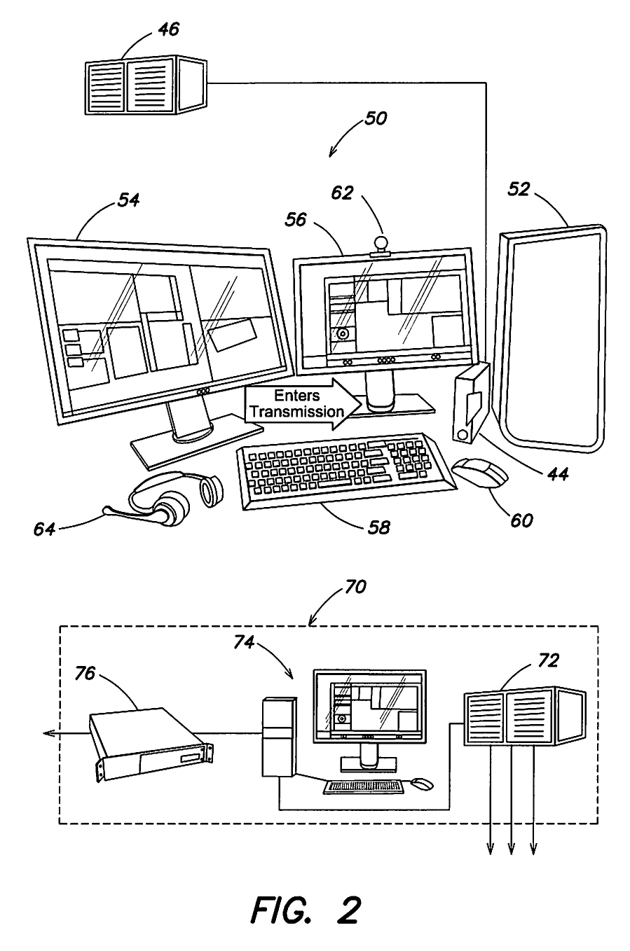

The gateway 70 can provide the video or audiovisual signal to the proprietary codec to others who have an established vpn with the gateway, and simultaneously encode the video and/or audiovisual signal to a conventional video Internet format for transmission over the worldwide web. In a preferred embodiment as shown in FIG. 2, the gateway 70 includes a server 72 and a processor 74. The server stores or distributes the video stream to other users, including the processor 74. The processor 74 decodes the video signal into a DVI signal, which is provided to a scan converter 76. The scan converter converts the DVI signal to a broadcast signal, for example, HD-SDI, and provides it to a standards-based video codec, such as h.264 or mpeg-4. This signal is then transmitted to a content delivery network, such as Akamai and Limelight, for distribution to one or more computers for viewing with a web browser via the Internet.

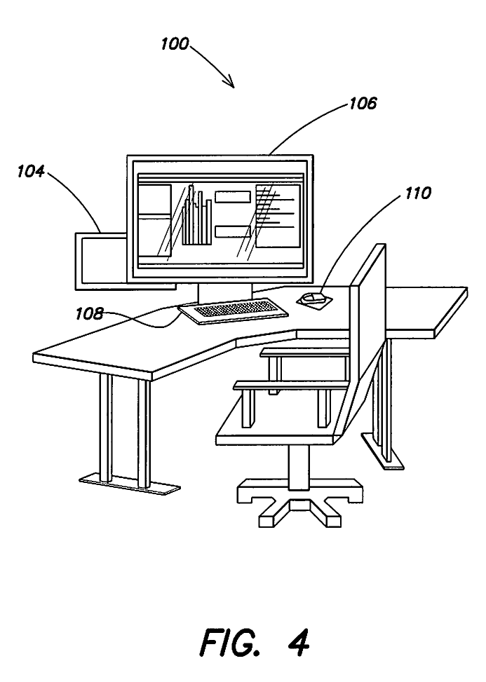

The signal arriving at the gateway 70 can also be directly communicated by the gateway in its proprietary encoding to one or more computers that receive the signal, decode it, and allow a remote user to participate in the procedure using their own computer 100 (FIG. 4). The computer 100 preferably includes a processor 104, a display 106, and one or more input devices, such as a keyboard 108 and a mouse 110. The remote user can use the keyboard 108 and the mouse 110 to issue commands which are communicated back to the consolidating and controlling computer system 34 to operate the various separate computer-controlled medical systems 22A-D.

In accordance with another aspect of this disclosure, a system can be provided, for example, as part of the studio production console, the system can anonymize regions of the video sources which the moderator would like to block from the audience. This can be used to limit the visibility of patient information making the collaboration and broadcast events HIPAA compliant. The anonymization feature would preferably be enabled or disabled by the moderator at will. In one embodiment, the size and position of every video window within the consolidated view is tracked in real-time by virtue of the system which consolidates the video source sending this information through an interface. The moderator could ahead of time define regions to block or crop in each video window or alternatively, use the defaults that have been defined for typical areas to block in each window type. Default positions can be predetermined for the systems commonly used, and provided in a look-up table that the user can select when setting up the system. With the location of patient data known, the privacy of this data can be assured by obscuring the image in the critical locations. When anonymization is enabled, the real-time size and position of each window is used to calculate the size and position of each defined anonymization region for blocking or cropping in real-time while viewing the information.

Alternatively, OCR text recognition of the procedure video or audiovisual signal can be used to identify the regions to block or crop. Text recognized can then be compared to a list of standard medical terms expected to be on the display, and any unrecognized text can be obscured to prevent disclosure of private patient information. Alternatively, text recognized can be compared to a list of personal information about the patient, and matching text can be obscured to prevent disclosure of private patient information.

The studio production console can be integrated with telepresence systems which contain bi-directional audio/video from the procedure room (or control room) to the studio console. In one embodiment, a lab telepresence endpoint is connected to an input of the video consolidation system in the procedure room or control room. The lab telepresence system also connects to another studio telepresence endpoint in a remote location of the hospital adjacent to the studio production console with its audio output connected to the studio production console. The telepresence systems facilitate bi-directional audio/video communication from the lab to the studio console, while the video of the lab telepresence system is integrated into a studio collaboration and broadcast event, by receiving the video integrated in the consolidated procedure view and the audio from the output of the studio telepresence endpoint for transmission to a global audience.

The studio production console includes a moderator's chat panel which allows viewers to enter comments and questions from their standard Internet web browser. No other viewer is able to see their questions or comments, giving the moderator full control to respond verbally or in written form back to the global audience. This panel also shows when participants enter and exit the event to give a sense of who is viewing.

What is claimed is:

1. A consolidated system for performing, recording, and distributing the performance and/or recordation of medical procedures, the consolidated system comprising:
a plurality of computer-controlled medical systems each having one or more input devices; and
an aggregation system for aggregating information pertaining to a medical procedure and/or pertaining to use of one or more of the medical systems to perform a medical procedure, the information having a plurality of sources, forms, and formats, the aggregation system configured to:
provide a preview of the information to allow a user to combine and/or edit the information; and
provide transmission of the combined and/or edited information to one or more recipients via a network.

2. The consolidated system of claim 1 wherein the information comprises at least one of the following: video, audio, recordation of the medical procedure, display information provided by one or more of the medical systems, telepresence information, and information received via the network from a remote user of the consolidated system.

3. The consolidated system of claim 1 wherein the network comprises a central gateway through which the aggregation system provides the transmission.

4. The consolidated system of claim 1 wherein the computer-controlled medical systems comprise at least one of the following: a remote navigation system, a localization system, an imaging system, and an electrocardiographic system.

5. The consolidated system of claim 1, configured to anonymize one or more portions of the information, the anonymizing performed using (a) size and positioning of one or more display windows, (b) size and positioning of one or more areas, and/or (c) a look-up table, substantially in real-time to calculate the portions.

6. The consolidated system of claim 1 wherein the aggregation system is configured to provide the preview and/or transmission generally in real-time.

7. The consolidated system of claim 1 wherein the aggregation system is configured to provide synchronization of the information.

8. A consolidated system for performing, recording, and distributing the performance and/or recordation of medical procedures, the consolidated system comprising:
a plurality of computer-controlled medical systems each having one or more input devices, each medical system configured to generate a medical system display;
a consolidation system for consolidating the medical system displays into a composite display, the consolidation system providing one or more control devices for controlling the medical systems via the consolidation system, as indicated by a user using the composite display; and
an aggregation system for aggregating information pertaining to a medical procedure and/or pertaining to use of the consolidation system and/or medical systems to perform a medical procedure, the information having a plurality of sources, forms, and formats, the aggregation system configured to:
provide a preview of the information to allow a user to combine and/or edit the information; and
provide transmission of the combined and/or edited information to one or more recipients via a network.

9. The consolidated system of claim 8 wherein the information comprises at least one of the following: video, audio, recordation of the medical procedure, telepresence information, and information received via the network from a remote user of the consolidated system.

10. The consolidated system of claim 8 wherein the network comprises a central gateway through which the aggregation system provides the transmission.

11. The consolidated system of claim 8 wherein the computer-controlled medical systems comprise at least one of the following: a remote navigation system, a localization system, an imaging system, and an electrocardiographic system.

12. The consolidated system of claim 8, configured to anonymize one or more portions of the information.

13. The consolidated system of claim 12, wherein anonymizing one or more portions of the information comprises tracking one or more video windows in real-time in a display to block, crop, and/or obscure the one or more portions.

14. The consolidated system of claim 12, wherein performance of the anonymizing is selectable by a user.

15. The consolidated system of claim 8 wherein the aggregation system is configured to provide the preview and/or transmission generally in real-time.

16. The consolidated system of claim 8 wherein the aggregation system is configured to provide synchronization of the information.

17. A method of providing medical information comprising:
obtaining information from a plurality of medical information sources, the information having a plurality of sources, forms, and formats;
combining, previewing and editing the information to provide a consolidated information stream; and
transmitting the consolidated information stream to one or more recipients.

18. The method of claim 17, further comprising anonymizing selected portions of the information stream.

19. The method of claim 18, wherein anonymizing comprises:
identifying visual information pertaining to a patient; and
tracking the identified information in the portions of the information stream.

20. The method of claim 17, wherein the information includes at least one of the following: video, audio, recordation of a medical procedure, telepresence information, and information received via a network from the one or more recipients.

21. A studio production console comprising at least a preview display and a transmit display whereby a plurality of video sources are managed by a moderator who opens and/or moves each video source into the transmit display to in turn, share the consolidated video to others over a network.

22. The console according to claim 21, whereby the video is combined with audio.

23. The console according to claim 21, whereby the video sources include but are not limited to a procedure room video source, a local video source, a remote video source, a telepresence system source, a prestored video source, and/or a network source.

24. A studio production console which integrates telepresence as described.

25. A method of automatically anonymizing regions of a consolidated display whereby the size and position of each window is utilized in real-time to calculate regions, the size and position of areas to block or crop from pre-defined areas in a defaults table, or as defined by the user ahead of time.

26. A method of automatic anonymization using optical character recognition (OCR).
